(19) United States
(12) Patent Application Publication
(10) Pub. No.: US 2011/0032997 A1
(43) Pub. Date: Feb. 10, 2011

(54) DECODING DEVICE

(75) Inventors: Tien Ping Chua, Singapore (SG); Mi Michael Bi, Singapore (SG)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/937,155

(22) PCT Filed: Apr. 17, 2009
(86) PCT No.: PCT/JP2009/001783

§ 371 Date: Oct. 8, 2010

(30) Foreign Application Priority Data
Apr. 25, 2008 (JP) 2008-116174 2008

(51) Int. Cl. H04N 7/12

(52) U.S. Cl. 375/240.25; 375/E07.027

(57) ABSTRACT

Provided is a decoding device which can perform video decoding in a real time with a sophisticated video specification requiring a frequent access to an external memory. A video decoding device (100) includes a hardware video decoder (115) which executes decoding of a pixel coefficient and write of a reconfigured picture into an external memory (110). A hardware video decoder (115) includes: a hardware engine pipeline (201) formed by a plurality of hardware engines requiring a DMA read access or a DMA write access to the external memory (110) or both of the accesses; and a hardware video decoder DMA controller (200) which adjusts all the DMA accesses from the hardware engines to one DMA channel or a plurality of DMA channels to a DMA controller (111).

### TECHNICAL FIELD

The present invention relates to a decoding apparatus that performs high-throughput video decoding, and, more specifically, relates to a decoding apparatus applicable to an electronic system that performs video decoding sharing use of an external memory among a plurality of components in an electronic system.

### BACKGROUND ART

A digital video decoding system is usually composed of a core processor and a hardware video decoder. A core processor parses elementary video bit streams at a macroblock level and above, sometimes with assistance from hardware engines. When a core processor is at a level equal to or higher than a macroblock level, the core processor parses, for example, sequence headers, slice headers, picture headers or macroblock headers.

A core processor controls a hardware video decoder that decodes pixel coefficients using obtained information. A hardware video decoder is usually constructed by a pipeline of dedicated hardware engines dedicated to perform specific decoding functions. Examples of such decoding functions include variable length decoding, dequantization, inverse transform, motion compensation, intra prediction and deblocking filtering.

Some of these hardware engines need to use an external memory. In most of video decoding systems, these engines should share an external memory in order to reduce cost. This external memory is also usually shared with other components in a larger electronic system (e.g. a host processor, a demultiplexing processor, a core processor and a display unit.) The host processor controls the electronic system, the demultiplexing processor demultiplexes a compressed bit stream into elementary video and audio bit streams, and the display unit performs post-processing and outputs a decoded picture.

The electronic system has a direct memory access (DMA) controller that prioritizes and arbitrates DMA access requests from components in the electronic system. The DMA controller grants the memory access right to only one of DMA access requests at any time. Components in the electronic system can have a plurality of DMA access channels to the DMA controller for requesting DMA access and for subsequent DMA transactions after the request is granted.

Patent Document 1 describes a method of operating a video decoding system. The video decoding system described in Patent Document 1 has a bridge that bridges between various modules of the video decoding system and the system memory. This bridge provides an interconnection network to connect all the other modules in the video decoding system. In addition, this bridge includes DMA engines to process memories in the decoder system (e.g. a shared decoder memory and local memory units in individual modules). The bridge module illustratively includes an asynchronous interface capability and supports different clock rates between the decoding system and the main memory bus, with either clock frequency being greater than the other.

The bridge module described in Patent Document 1 has a complex design, being connected to a large number of modules, and has to arbitrate a large number of DMA access requests from these modules. It is difficult to guarantee real-time decoding for high-resolution pictures encoded with new advanced video standards. This is particularly so, under the condition where DMA latencies may be large or variable due to the dynamics of the electronic system during operation.

### CITATION LIST

### Patent Literature

### PTL 1: U.S. Patent 2003/0185298

### SUMMARY OF INVENTION

### Technical Problem

However, as for the above-described conventional electronic system, it is difficult for a DMA controller to prioritize and arbitrate DMA access requests from components each having plurality of DMA access channels in the electronic system. Conventionally, DMA arbitration is performed through one or more schemes, such as round robin and assigning the priority to each DMA request. These conventional schemes are unable to meet increasing DMA access demands and changes in DMA access demands from hardware engines and other components in the electronic system during operation of the electronic system.

Moreover, due to increase requirements in compression efficiency, many of advanced video standards such as H.264/AVC, SMPTE VC1 and China AVS have used more visual tools, and some of these visual tools need to use an external memory to store intermediate decoded data. This results in an increase in the number of DMA access channels to the external memory and it will be more difficult to prioritize DMA requests through these DMA access channels efficiently. It is increasingly difficult to meet the required real-time decoding throughput when DMA latencies may be large or variable due to the dynamics of an electronic system during operation.

It is therefore an object of the present invention to provide a decoding apparatus to allow real-time video decoding in an advanced video standard requiring frequent accesses to an external memory.

In addition, it is another object of the present invention to provide a decoding apparatus allowing reduction in the amount of on-chip storage required and allowing reduction in cost.

### Solution to Problem

The decoding apparatus according to the present invention adopts a configuration to include: an external memory; a direct memory access controller that controls direct memory access to the external memory; and a plurality of components that share use of the external memory through the direct memory access controller, wherein the plurality of components include: a hardware video decoder that decodes pixel coefficients and writes a reconstructed picture to the external memory; and a core processor that controls the hardware video decoder using parameters obtained by analyzing a compressed video bit stream.

### ADVANTAGEOUS EFFECTS OF INVENTION

According to the present invention, there is only one or a few DMA channels to a DMA controller during video decoding by providing a hardware video decoder that decodes pixel coefficients and writes a reconstructed picture to an external memory. This reduces the number of channels to arbitrate, so that it is possible to reduce the complexities of the DMA controller.

In addition, high-throughput decoding is allowed by providing a video decoder DMA controller that arbitrates all accesses from a plurality of hardware engines into one DMA channel or a plurality of DMA channels to the DMA controller, without halting processing of hardware engines caused by waiting for data to be DMA out or wait for data to be DMA in.

This makes real-time video decoding possible in an environment where DMA latencies to the shared external memory may be large or variable.

As a result of this, real-time video decoding is achieved in an advanced video standard (e.g. H.264/AVC, SMPTE VC1, China AVS) requiring frequent accesses to an external memory. This real-time video decoding allows reduction in the amount of on-chip storage required in an environment where more external memories are used, so that it is possible to reduce cost. In addition, it is possible to reduce the complexities of the DMA controller in an external memory by reducing the number of DMA channels that should be arbitrated. Moreover, real-time decoding is allowed under the condition where DMA latencies may be large or variable due to the dynamics of an electronic system during operation.

### BRIEF DESCRIPTION OF DRAWINGS

FIG. 1 is a block diagram showing a configuration of a coding apparatus according to an embodiment of the present invention;

FIG. 2 is a block diagram showing a configuration of a hardware video decoder in the decoding apparatus according to the embodiment of the present invention; and

FIG. 3 is a drawing showing a configuration of a video coder DMA controller with hardware engine interfaces and a DMA channel.

### DESCRIPTION OF EMBODIMENTS

Now, embodiments of the present invention will be described in detail with reference to the accompanying drawings.

### Embodiment

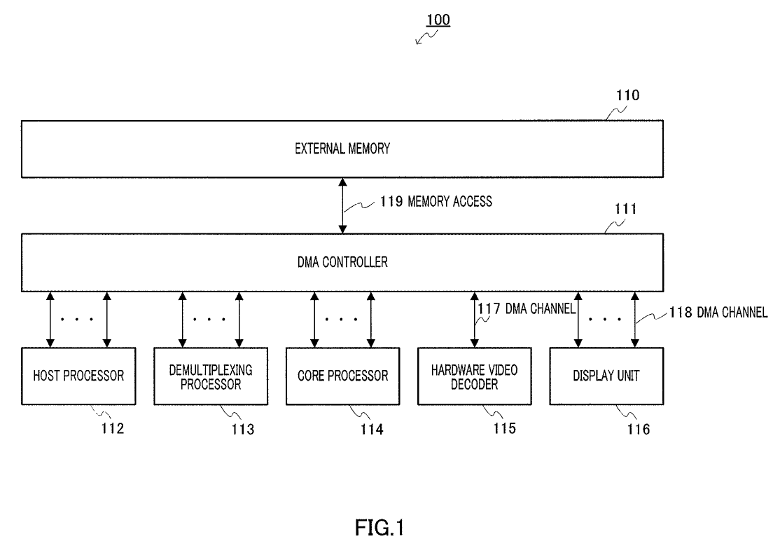

FIG. 1 is a block diagram showing the configuration of a video decoding apparatus according to an embodiment of the present invention. With the present embodiment, the present invention is applied to a video decoding apparatus, which is an electronic system, performing video decoding tasks while sharing use of an external memory among a plurality of components in the electronic system.

In FIG. 1, video decoding apparatus 100 is configured to include external memory 110, DMA controller 111 that controls DMA access to external memory 110, and plurality of components that share use of external memory 110 through DMA controller 111. The plurality of components include host processor 112, demultiplexing processor 113, core processor 114, hardware video decoder 115 and display unit 116.

DMA controller 111 and hardware video decoder 115 are connected through DMA channel 117, and DMA controller 111 and display unit 116 are connected through DMA channel 118. In addition, external memory 110 and DMA controller 111 are connected through memory access 119.

DMA controller 111 controls memory access channels to external memory 110 such that only one component is able to perform memory access 119 to external memory 110 at any time. DMA controller 111 registers DMA access requests and prioritizes and schedules them to perform in order memory access 119 to external memory 110.

Host processor 112 provides overall system control.

Demultiplexing processor 113 demultiplexes a compressed bit stream into elementary video and audio bit streams and stores the result in external memory 110.

Core processor 114 controls hardware video decoder 115 using parameters obtained by analyzing the compressed video bit stream. Core processor 114 parses the elementary video bit stream and controls hardware video decoder 115 that decodes pixel coefficients using the obtained information.

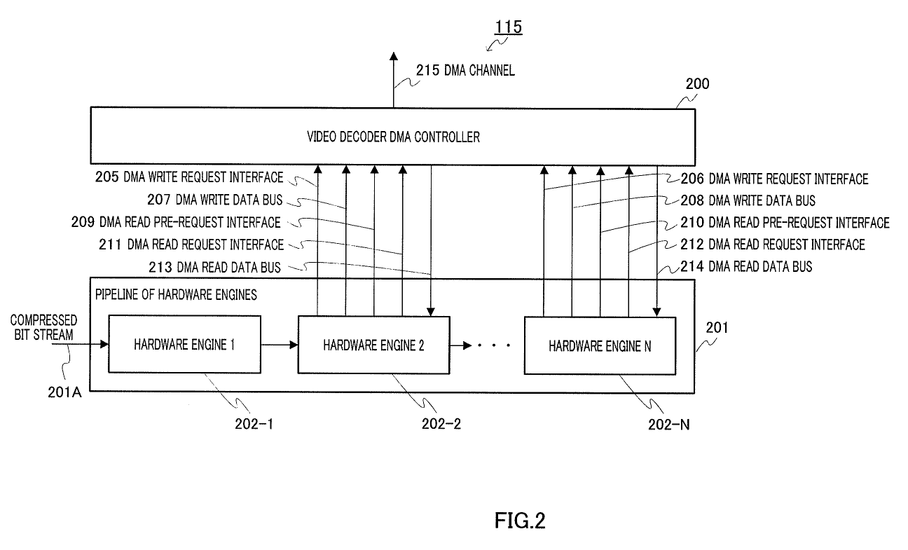

Hardware video decoder 115 decodes pixel coefficients and writes a reconstructed picture to the external memory. Hardware video decoder 115 has pipeline 201 (described later with FIG. 2) of hardware engines that perform main tasks of texture decoding and writing reconstructed pictures to the external memory 110. Reconstructed picture are read by display unit 116 and displayed.

Display unit 116 displays decoded pictures.

The above-described components 112 to 116 each need one or more DMA channels 118 to access external memory 110.

There are a plurality of hardware engines requiring memory access 119 to external memory 110 inside hardware video decoder 115. Hardware video decoder 115 arbitrates inside all DMA access requests from hardware engines in order to access external memory 110 through only one DMA channel 117.

This allows a dedicated arbitration scheme and DMA method that achieves high-throughput video decoding to be implemented inside hardware video decoder 105 independent of DMA controller 101. This also reduces the number of DMA channels to be handled by DMA controller 111, and therefore reduces the complexities of DMA controller 111.

FIG. 2 is a block diagram showing a configuration of hardware video decoder 115.

In FIG. 2, hardware video decoder 115 is configured to include pipeline 201 formed by a plurality of hardware engines for video decoding that need DMA read access, DMA write access or both DMA read and write access to external memory 110 and, video decoder DMA controller 200 that arbitrates all DMA accesses from a plurality of hardware engines into one DMA channel or a plurality of DMA channels to DMA controller 111. Video coder DMA controller 200 is a unified DMA controller for a hardware video decoder.

Pipeline 201 of hardware engines includes multiple hardware engines 202-1, 202-2, . . . , 202-N that process compressed video stream 201A.

Multiple hardware engines 202-1, 202-2, . . . , 202-N have DMA read pre-request issuing means that issue DMA read pre-requests to the respective corresponding DMA read requests, transact DMA read requests for current chuck of data for video decoding and concurrently issue DMA read pre-requests for subsequent chuck of data. To be more specific, multiple hardware engines 202-1, 202-2, . . . , 202-N issue DMA write requests through DMA write request interfaces 205 and 206 to video decoder DMA controller 200. After the corresponding DMA write request is granted, the write data is transferred through DMA write buses 207 and 208.

Multiple hardware engines 202-1, 202-2, . . . , 202-N issue DMA read requests through DMA read request interfaces 211 and 212 to video decoder DMA controller 200. Hardware engines 202-1, 202-2, . . . , 202-N have to issue DMA read pre-requests through respective corresponding DMA read pre-request interfaces 209 and 210 to video decoder DMA controller 200 before issuing DMA read requests. Hardware engines 202-1, 202-2, . . . , 202-N issue these DMA read requests after the respective corresponding DMA read pre-requests are transacted. Next, each of hardware engines 202-1, 202-2, . . . , 202-N reads data from DMA read data buses 213 (214) after the DMA read request access is granted.

Video decoder DMA controller 200 allows high-throughput video decoding from compressed bit stream 201A. Video decoder DMA controller 200 collects and transacts DMA write requests from hardware engine 201 in the hardware video decoder through DMA write request interfaces 205 and 206, collects DMA read pre-requests through DMA read pre-request interfaces 209 and 210 and sends these requests out through DMA channel 215 serially. Before sending a DMA write request through DMA channel 215, data corresponding to the DMA write request must have already been transferred from each hardware engine 2012-1, 202-2, . . . , 202-N to video decoder DMA controller 200.

This enables video decoder DMA controller 200 to transfer write data out and read data in at a low latency via DMA channel 215 under the control of DMA controller 111 in FIG. 1.

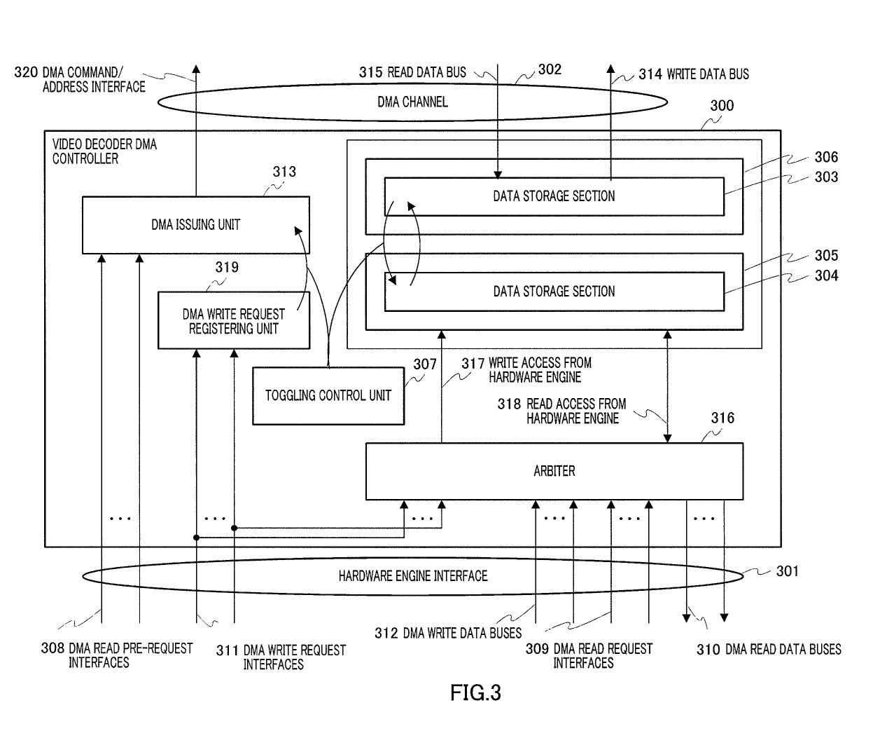

FIG. 3 is a drawing showing the configuration of video decoder DMA controller 300 with its hardware engine interface 301 and DMA channel 302. Video decoder DMA controller 300 shown in FIG. 3 is applicable to video decoder DMA controller 200 shown in FIG. 2.

In FIG. 3, video decoder DMA controller 300 is configured to include data storage sections 303 and 304, toggling control unit 307, DMA issuing unit 313, arbiter 316 and DMA write request registering unit 319. In FIG. 3, when being allocated by decoder DMA controller 300, data storage sections 303 and 304 are shown on data storage sections 305 and 306, respectively.

Data storage sections 303 and 304 are two same (dual) data storage means for buffering DMA read data and DMA write data. Data storage sections 303 and 304 can be dynamically toggled to be allocated between data transfer by DMA controller 111 and data transfer by pipeline 201 of hardware engines.

Toggling control unit 307 toggles use of two data storage sections 303 and 304 between data transfer by DMA controller 111 and data transfer by pipeline 201 of hardware engines.

To be more specific, toggling control unit 307 toggles use of two data storage sections 303 and 304 under the following condition: the designated number of DMA read pre-requests have been transacted, and all DMA write requests in DMA issuing unit 313 have been transacted by DMA controller 111. In addition, toggling control unit 307 toggles use of two data storage sections 303 and 304 under the following condition: the designated number of DMA write requests have been transacted, and all DMA read requests corresponding to read data in data storage sections 303 and 304 allocated for data transfer through pipeline 201 of hardware engines have been transacted.

In addition, toggling control unit 307 determines criteria for the designated number of DMA read requests based on the amount of read data required to transact one macroblock for hardware engines requiring DMA read access and toggles use of data storage sections 303 and 304, and determines criteria for the number of designated DMA write requests based on the amount of write data after one macroblock is transacted for hardware engines requiring DMA write access and toggles use of data storage sections 303 and 304.

DMA issuing unit 313 issues DMA requests for DMA controller 111 to the accepted DMA read pre-requests from hardware engines 202-1, 202-2, . . . , 202-N, and the registered DMA write requests transferred from DMA write request registering unit 319.

Arbiter 316 is an arbiter for DMA requests from hardware engines. Arbiter 316 arbitrates DMA read requests and DMA write requests for data storage sections 303 and 302 allocated to the pipeline of hardware engines.

DMA write request registering unit 319 registers a DMA write request, and, at the time two data storage sections 303 and 304 are toggled, transfers the registered DMA write request to DMA issuing unit 313.

Next, operations of video decoder DMA controller 300 will be described.

In video decoder DMA controller 300, there are two same data storage sections 303 and 304. Video decoder DMA controller 300 allocates one data storage section 305 to data access from hardware engine interface 301 and allocates the other data storage section 306 to data access from DMA channel 302 at any time. Data storage sections 305 and 306 correspond to two data storage sections 303 and 304 allocated by video decoder DMA controller 300, respectively.

Upon completion of data access from hardware engine interface 301 and upon completion of data access from DMA channel 302, video decoder DMA controller 300 reallocates two data storage sections 303 and 304 between data access from hardware engine interface 301 and data access from DMA channel 302.

Toggling control unit 307 controls when to toggle data storage sections 303 and 304 between data access from hardware engine interface 301 and data access from DMA channel 302.

Hardware engine interface 301 has multiple DMA read pre-request interfaces 308, multiple DMA read request interfaces 309, multiple DMA reading buses 310 from hardware engines, multiple DMA write request interfaces 311 and multiple DMA write data buses 312.

Hardware engines requiring read access to external memory 110 (FIG. 1) use multiple DMA read pre-request interfaces 308, multiple DMA read request interfaces 309, multiple DMA read data buses 310 and hardware engine interface 301. Hardware engines requiring write access to external memory 110 (FIG. 1) use multiple DMA write request interfaces 311, multiple DMA write data buses 312 and hardware engine interface 301.

Video decoder DMA controller 300 registers DMA read pre-requests issued by hardware engines through multiple DMA read pre-request interfaces 308 on DMA issuing unit 313. Then, these DMA read pre-requests are issued to DMA controller 111 in FIG. 1 through DMA command/address interface 320 via DMA channel 302. Then, read data from external memory 110 (FIG. 1) is received through read data bus 315 and stored in one of data storage sections 305 and 306 (here, data storage section 306). After toggling of data storage section 306, hardware engines make DMA read request through multiple DMA read request interfaces 309 in order to access data in data storage section 305 allocated for data access from hardware engine interface 301.

When hardware engines make DMA write request through DMA read request interfaces, arbiter 316 for DMA requests from hardware engines arbitrates these requests.

Arbiter 316 for DMA requests from hardware engines arbitrates read or write accesses to data storage section 305 and 306 every time DMA read requests or DMA write requests from hardware engines are translated to read access 317 or write access 318 to data storage sections 305 and 306.

After arbiter 316 for DMA requests from hardware engines grants the DMA write request from a hardware engine, the hardware engine transfers the corresponding DMA write data to multiple write data buses 312.

Next, DMA write request registering unit 319 registers the transacted DMA write request. Upon toggling of data storage section 306, DMA write request registering unit 319 transfers all registered write requests to DMA issuing unit 313.

DMA issuing unit 313 issues a DMA write command and a memory address to DMA command/address interface 320. Then, data from data storage section 306 allocated to DMA channel 302 is sent via data bus 314.

The data access from hardware engine interface 301 to a data storage section is said to be completed at the time all hardware engines have completed reading all the data that they have requested through previously issued DMA read pre-requests and all hardware engines have completed writing a specific amount of DMA write data. The data access from DMA channel 302 to a data storage section is said to be completed at the time all write data have been transferred out to DMA controller 111, a specific number of DMA read pre-requests have been transacted and their read data is transferred in from DMA controller 111.

As described above, according to the present embodiment, video decoding apparatus 100 has external memory 110; DMA controller 111 that controls DMA access to external memory 110; hardware video decoder 115 shares use of external memory 110 through DMA controller 111, decodes pixel coefficients and writes a reconstructed picture to external memory 110; and core processor 114 controls hardware video decoder 115 using parameters obtained by analyzing compressed video bit streams. Having the above-described video decoder 115 enables video decoding with only one or a few DMA channels to DMA controller 111. By this means, the number of channels to be arbitrated is reduced, so that it is possible to reduce the complexities of DMA controller 110.

In addition, with the present embodiment, hardware video decoder 115 has pipeline 201 of a plurality of hardware engines that need DMA read access, DMA write access or both DMA read and write access to external memory 110, and video decoder DMA controller 200 that arbitrates all DMA accesses from a plurality of hardware engines into one DMA channel or a plurality of DMA channels to DMA controller 111. Moreover, video decoder DMA controller 200 has two same data storage sections 303 and 304 to buffer DMA read data and DMA write data, and therefore enables DMA accessing and video decoding to progress concurrently. This helps to achieve real-time video decoding in an environment where DMA latencies to shared external memory 110 may be large or variable.

That is, video decoder DMA controller 300 has two same data storage sections 303 and 304, and therefore allocates one data storage section to transfer data from/to external memory 110 and allocates the other data storage section to transfer from/to pipeline 201 of hardware engines at any time. This enables prevention of halting processing of hardware engines due to wait for data to be DMA out or wait for data to be DMA in, and therefore enables high-throughput decoding. In order to accomplish this, hardware engines will have to pre-fetch data from external memory 110 to one of the data storage sections and then subsequently read them out to hardware engines. The data from hardware engines to be DMA out is written to the other data storage section and then subsequently written to external memory 110. This makes real-time video decoding possible in an environment where DMA latencies may be large or variable.

The above description is illustration of preferred embodiments of the present invention and the scope of the invention is not limited to this.

Although the name “video decoding apparatus” is used in the present embodiment for ease of explanation, “decoding device”, “digital video decoding system” and so forth are possible naturally.

Moreover, the type, the number, the connection method and so forth of a core processor, a hardware video decoder and a host processor constituting the above-described decoding apparatus, and, in addition, a configuration example of data storage sections is not limited to above-described embodiment.

The disclosure of Japanese Patent Application No. 2008-116174, filed on Apr. 25, 2008, including the specification, drawings and abstract, is incorporated herein by reference in its entirety.

### INDUSTRIAL APPLICABILITY

The decoding apparatus according to the present invention is suitable for apparatuses to perform high-throughput video decoding. In addition, the decoding apparatus is applicable to an electronic system that performs video decoding while sharing use of an external memory among a plurality of components in the electronic system. For example, it is possible to achieve real-time video decoding in advanced video standards such as H.264/AVC, SMPTE VC1 and China AVS that require frequent accesses to an external memory.

### REFERENCE SIGNS LIST

100 Decoding apparatus
110 External memory
111 DMA controller
112 Host processor
113 Demultiplexing processor
114 Core processor
115 Hardware video decoder
116 Display unit
201 Hardware engine pipeline
200, 300 Video decoder DMA controller
202-1, 202-2, . . . , 202-N Hardware engine
303 to 306 Data storage section
307 Toggling unit
313 DMA issuing unit
316 Arbiter for DMA requests from hardware engines
319 DMA writing request registering unit

1. A decoding apparatus comprising:
an external memory;
a direct memory access controller that controls direct memory access to the external memory; and
a plurality of components that share use of the external memory through the direct memory access controller,
wherein the plurality of components include:
a hardware video decoder that decodes pixel coefficients and writes a reconstructed picture to the external memory; and
a core processor that controls the hardware video decoder using parameters obtained by analyzing a compressed video bit stream.

2. The decoding apparatus according to claim 1, wherein the plurality of components further include:
a host processor;
a demultiplexing processor that demultiplexes the compressed bit stream into an elementary video/audio bit stream; and
a display unit that displays a decoded picture.

3. The decoding apparatus according to claim 1, wherein the hardware video decoder includes:
a plurality of hardware engines that need direct memory access read, direct memory access write or both direct memory access read and write access to the external memory; and
a video decoder direct memory access controller that arbitrates all direct memory accesses from the plurality of hardware engines into one direct memory access channel or a plurality of direct memory access channels to the direct memory access controller.

4. The decoding apparatus according to claim 3,
wherein the hardware engine includes a direct memory access read pre-request issuing section that issues a direct memory access read pre-request to each corresponding direct memory access read request, transacts the direct memory access read request for current chuck of data for video decoding and issues a direct memory access read pre-request for a subsequent chunk of data.

5. The decoding apparatus according to claim 3,
wherein the video decoder direct memory access controller is a unified direct memory access controller for the hardware video controller, the unified direct memory access controller includes:
two data storage sections that buffer direct memory access read data and direct memory access write data and that are able to be dynamically toggled for allocation between data transfer by the direct memory access controller and data transfer by a pipeline for the hardware engines;
an arbiter for direct memory access requests from the hardware engines that arbitrates direct memory access read requests and direct memory access write requests to the data storage sections allocated to the pipeline of the hardware engines;
a direct memory access write request registering unit that registers the direct memory access write request and transfers the registered direct memory access write request to a direct memory access issuing unit at the time the two data storage sections are toggled;
the direct memory access issuing unit that issues direct memory access requests for the direct memory access controller, to accepted direct memory access read pre-requests from the hardware engines and registered direct memory access write requests transferred from the direct memory access write request registering unit; and
a toggling control unit that toggles use of the two data storage sections between data transfer by the direct memory access controller and data transfer by the pipeline of the hardware engines,
wherein the toggling unit toggles use of the two data storage sections under following conditions:
a designated number of direct memory access read pre-requests have been transacted and all direct memory access write requests in the direct memory access issuing unit have been transacted by the direct memory access controller; and
a designated number of direct memory access write requests have been transacted and all direct memory access read requests corresponding to read data in the data storage sections allocated for data transfer through the pipeline of the hardware engines have been transacted.

6. The decoding apparatus according to claim 5, wherein the toggling control unit:
determines criteria for the designated number of direct memory access read pre-requests based on an amount of read data required to process one macroblock for the hardware engines requiring direct memory access read and toggles the data storage sections; and
determines criteria for the designated number of direct memory access write requests based on an amount of write data after one macroblock is processed for the hardware engines requiring direct memory access write and toggles the data storage sections.
